(19) United States
(12) Patent Application Publication
(10) Pub. No.: US 2018/0144659 A1
(43) Pub. Date: May 24, 2018

(54) ELECTRONIC TEACHING AID SOFTWARE SYSTEM AND METHOD OF GENERATING A CUSTOMIZED CURRICULUM

(71) Applicant: Marisha McGrorty, Phoenix, AZ (US)

(72) Inventor: Marisha McGrorty, Phoenix, AZ (US)

(21) Appl. No.: 15/684,868

(22) Filed: Aug. 23, 2017

Related U.S. Application Data
(60) Provisional application No. 62/424,351, filed on Nov. 18, 2016.

(51) Int. Cl. G09B 19/04; G06Q 10/10; G06F 19/00; H04L 12/58; H04L 29/08

(52) U.S. Cl. CPC G09B 19/04; G06Q 10/109; H04L 67/306; H04L 51/046; G06F 19/3418

(57) ABSTRACT

The electronic teaching aid software system and method of generating a customized curriculum having a collection of tools, educational information, therapy plans and strategies designed to assist speech/language pathologists in teaching students with speech/language delays/disabilities. The software further aids educational social networking between speech/language pathologists by linking them together using a combination of member forums and discussion boards. Students can be entered into a database with pre-made, and/or, customizable therapy plans which focus on a student's individual disability. Speech/language pathologists using the tools provided by the electronic teaching aid can plan, structure, and archive complete therapy plan outlines increasing their teaching efficiency on a per student level. The electronic teaching aid is a versatile program that can be accessed from a multitude of devices, inside or outside of the classroom by remote access.

### CROSS REFERENCE TO RELATED APPLICATION

The present application is related to and claims priority to U.S. Provisional Patent Application No. 62/424,351 filed Nov. 18, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of software applications and more specifically relates to an educational teaching aid software application.

### 2. Description of Related Art

A software application is a computer program designed to run on personal computers, tablet computers, mobile devices such as a smartphone, and other software devices. Software applications were originally offered for general productivity and information retrieval, including email, calendar, contacts, and stock market and weather information.

However, public demand and the availability of developer tools drove rapid expansion into other categories, such as software games, factory automation, GPS and location-based services, banking, order-tracking, ticket purchases and recently software medical applications. The explosion in number and variety of applications made discovery a challenge, which in turn led to the creation of a wide range of review, recommendation, and curation sources, including blogs, magazines, and dedicated online application-discovery services. Many new applications are desirable to provide convenient solutions to the users.

U.S. Pub. No. 2008/0070224 to John Stuppy relates to a system and method for generation of worksbooks by software modules received from a central station. The described system and method for generation of worksbooks by software modules received from a central station includes a computer based system for the assessment, management and instruction of students, and for the delivery of work pages and other instructional materials in the form of electronic student workbooks. The computer based assessment of the student produces a student profile including skill gaps or learning objectives. Teacher (20) and student (22) workstations are networked CPUs with pen-based tablet inputs, and displays network with a central processor (10) and data base. A director workstation may also be networked with the central processor. The central processor generates a teacher workbook either directly or with input from the director workstation. The teacher, or teacher and director together, assemble an electronic student workbook containing instructional materials correlated with the student profile. The system tracks useful data such as instructional material (e.g., textbook pages, work sheets, software, simulations, tests, etc.) delivered to students.

### BRIEF SUMMARY OF THE INVENTION

In view of the foregoing disadvantages inherent in the known software applications art, the present disclosure provides a novel electronic teaching aid software system and method of generating customized curriculums. The general purpose of the present disclosure, which will be described subsequently in greater detail, is to provide a means allowing a speech/language pathologist to tailor individual student therapy plans in a comprehensive software environment. The present invention is superior to other systems in that it effectively categorizes, organizes, stores, and assigns specific teaching/therapeutic techniques customizable for each student's need.

An electronic teaching aid software system and method of generating a customized curriculum is disclosed herein. The electronic teaching aid software system and method of generating a customized curriculum has a collection of tools, educational information, therapy plans and strategies designed to assist speech/language pathologists in teaching students with speech/language delays/disabilities. The method comprises providing an electronic teaching aid software system, comprising a computing device hosting an application and in communication with a student-user via a network, a database coupled to the computing device and storing therein a plurality of courses to be combined into a course-outline dependent upon a skill level of, the student-user based on a student-profile. The electronic teaching aid software system generates a course-outline to the user via the network and allows a speech/language pathologist to track progress of the student-user via a plurality of therapist workstations. The method further comprising receiving information on a skill level of a student-user via a student-profile, analyzing the student-profile, generating therapy plans and activities, tracking of the progress/skill level of the student, and updating therapy plans and activities.

The software further aids educational social networking between speech/language pathologists by linking them together using a combination of member forums and discussion boards. Student-users may be entered into a database with pre-made, and/or, customizable therapy plans which focus on a student's individual disability. Speech/language pathologists using the tools provided by the electronic teaching aid can plan, structure, and archive complete therapy plan outlines increasing their teaching efficiency on a per student level. The electronic teaching aid is a versatile program that can be accessed from a multitude of devices, inside or outside of the classroom by remote access.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an electronic teaching aid software system and method of generating customized curriculums, constructed and operative according to the teachings of the present disclosure.

FIG. 1 is a detailed view of the electronic teaching aid software system and method of generating a customized curriculum during an ‘in-use’ condition, according to an embodiment of the disclosure.

FIG. 2 is a screen view of the electronic teaching aid software system and method of generating a customized curriculum of FIG. 1, according to an embodiment of the present disclosure.

FIG. 3 is a screen view of the electronic teaching aid software system and method of generating a customized curriculum of FIG. 1, according to an embodiment of the present disclosure.

FIG. 4 is a screen view of the electronic teaching aid software system and method of generating a customized curriculum of FIG. 1, according to an embodiment of the present disclosure.

FIG. 5 is a screen view of the electronic teaching aid software system and method of generating a customized curriculum of FIG. 1, according to an embodiment of the present disclosure.

FIG. 6 is a screen view of the electronic teaching aid software system and method of generating a customized curriculum of FIG. 1, according to an embodiment of the present disclosure.

FIG. 7 is a screen view of the electronic teaching aid software system and method of generating a customized curriculum of FIG. 1, according to an embodiment of the present disclosure.

FIG. 8 is a screen view of the electronic teaching aid software system and method of generating a customized curriculum of FIG. 1, according to an embodiment of the present disclosure.

FIG. 9 is a screen view of the electronic teaching aid software system and method of generating a customized curriculum of FIG. 1, according to an embodiment of the present disclosure.

FIG. 10 is a screen view of the electronic teaching aid software system and method of generating a customized curriculum of FIG. 1, according to an embodiment of the present disclosure.

FIG. 11 is a screen view of the electronic teaching aid software system and method of generating a customized curriculum of FIG. 1, according to an embodiment of the present disclosure.

FIG. 12 is a screen view of the electronic teaching aid software system and method of generating a customized curriculum of FIG. 1, according to an embodiment of the present disclosure.

FIG. 13 is a screen view of the electronic teaching aid software system and method of generating a customized curriculum of FIG. 1, according to an embodiment of the present disclosure.

FIG. 14 is a screen view of the electronic teaching aid software system and method of generating a customized curriculum of FIG. 1, according to an embodiment of the present disclosure.

FIG. 15 is a screen view of the electronic teaching aid software system and method of generating a customized curriculum of FIG. 1, according to an embodiment of the present disclosure.

FIG. 16 is a screen view of the electronic teaching aid software system and method of generating a customized curriculum of FIG. 1, according to an embodiment of the present disclosure.

FIG. 17 is a screen view of the electronic teaching aid software system and method of generating a customized curriculum of FIG. 1, according to an embodiment of the present disclosure.

FIG. 18 is a diagram illustrating the electronic teaching aid software system and method of generating a customized curriculum of FIG. 1, according to an embodiment of the present disclosure.

FIG. 19 is a diagram illustrating the electronic teaching aid software system and method of generating a customized curriculum of FIG. 1, according to an embodiment of the present disclosure.

FIG. 20A is a diagram illustrating the electronic teaching aid software system and method of generating a customized curriculum of FIG. 1, according to an embodiment of the present disclosure.

FIG. 20B is a diagram illustrating the electronic teaching aid software system and method of generating a customized curriculum of FIG. 1, according to an embodiment of the present disclosure.

FIG. 21 is a diagram illustrating the electronic teaching aid software system and method of generating a customized curriculum of FIG. 1, according to an embodiment of the present disclosure.

FIG. 22 is a diagram illustrating the electronic teaching aid software system and method of generating a customized curriculum of FIG. 1, according to an embodiment of the present disclosure.

FIG. 23 is a diagram illustrating the electronic teaching aid software system and method of generating a customized curriculum of FIG. 1, according to an embodiment of the present disclosure.

FIG. 24 is a diagram illustrating the electronic teaching aid software system and method of generating a customized curriculum of FIG. 1, according to an embodiment of the present disclosure.

FIG. 25 is a diagram illustrating the electronic teaching aid software system and method of generating a customized curriculum of FIG. 1, according to an embodiment of the present disclosure.

FIG. 26 is a diagram illustrating the electronic teaching aid software system and method of generating a customized curriculum of FIG. 1, according to an embodiment of the present disclosure.

FIG. 27A is a diagram illustrating the electronic teaching aid software system and method of generating a customized curriculum of FIG. 1, according to an embodiment of the present disclosure.

FIG. 27B is a diagram illustrating the electronic teaching aid software system and method of generating a customized curriculum of FIG. 1, according to an embodiment of the present disclosure.

FIG. 28 is a diagram illustrating the electronic teaching aid software system and method of generating a customized curriculum of FIG. 1, according to an embodiment of the present disclosure.

FIG. 29 is a flow diagram illustrating a method of use for electronic teaching aid software system and method of generating a customized curriculum, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a software applications and more particularly to an electronic teaching aid software system and method of generating customized curriculums as used to improve the educational teaching aid software applications.

Generally, the electronic teaching aid may be a software driven teaching tool allowing a speech/language pathologist to customize curriculum for individual students based on need. The electronic teaching aid may include customizable form fields such as calendars, student rosters, therapy plans, and a global dashboard. Other features may include a member's contact forum, a discussion board, an archive database, and a help desk. All tools may be conveniently accessed through the global dashboard giving the speech/language pathologist the ability to organize a complete student therapy plan throughout the entire school year using a single software application.

The present invention features the ability to view/analyze data across therapists/students (e.g., to determine how long it typically takes students to master a given goal, to determine which resources/strategies are the most effective, to understand the impact of students factors on progress, etc.). Interactive therapy activities may be pulled up within the application of the present invention. Therapists may share plans with each other via “playlists” for providing access to community knowledge.

In one embodiment of the present invention, electronic teaching aid software system and method of generating a customized curriculum may comprise a software program outlining an education/therapy plan for students with speech/language therapy needs.

The electronic teaching aid allows a speech/language pathologist to create a specific curriculum outline for students that may have different ranges of speech/language impairments, giving a speech/language pathologist a wide range of tools that can be accessed on a plurality of devices. The electronic teaching aid may be installed on devices such as a desktop or laptop computer, a tablet computer, or a mobile device. The versatility of the electronic teaching aid may allow speech/language pathologists to access these tools from a variety of locations via mobile log in to update information at any time. The electronic teaching aid may also prompt speech/language pathologist via pop-up message about upcoming events as well as therapy plans.

The electronic teaching aid software system and method of generating a customized curriculum tracks students' therapy goals, scheduled activities, and gauges student-user improvements. The global dashboard may comprise several tabs allowing for easy navigation throughout the program. These tabs may include, but not limited to, selections for a calendar, a student-user status, a therapy plan outline, a member's area, a discussion forum, an archives tab, and a help desk option. The global dashboard may allow for quick access to all tools available within the software. A list of student-users on the speech/language pathologist's caseload may be listed, along with the outline for a specific day therapy plan. A quick weekly schedule segment may show a brief view for that week.

A detailed listing of each student-user's curriculum may be displayed with customizable fields which may include, but are not limited, to name, date of birth, assigned therapist, individualized educational plan start date, evaluation date, eligibility, type of speech or language impairment, grade level, etc. Student-users may be added to the list on an as needed basis.

The therapy plan page may incorporate therapeutic strategies as well as course outlines dependent upon a specific student-user's speech/language disorder, and supply tools and suggestions for the speech/language pathologist. The speech/language pathologist may indicate a specific activity as a favorite activity in a specific student-user's profile which facilitates improved response from the student-user, which may also be notated. Notations may be done on each activity listed within the therapy plan for each student-user. There may be several customizable drop-down options for the level of skill, level within the therapy plan, and the area where the student-user needs the most improvement, although are not limited to these options.

Additional materials and videos may be uploaded and shared through the discussion board increasing the speech/language pathologist's community knowledge base within the software. Pertinent past student-user information and previous therapy plan structures may be archived for future reference. A help desk option may also be included to assist new speech/language pathologists with navigating through tools and materials located within the software.

The electronic teaching aid software system may be used across multiple devices and device platforms such as standard personal computers and non-standard personal computers, tablets, and smart devices such as smartphones. The flexibility of the electronic teaching aid software system may allow access to the software tools from any secure internet connection wirelessly. When the present invention is manipulated on for example on a touch screen the screen changes in appearance to provide access to necessary information and the like; a tangible output may thereby be achieved.

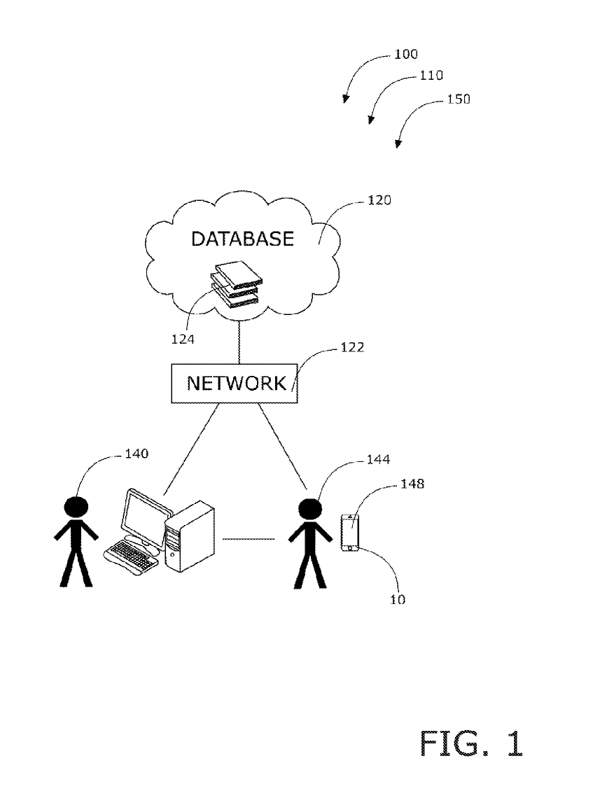

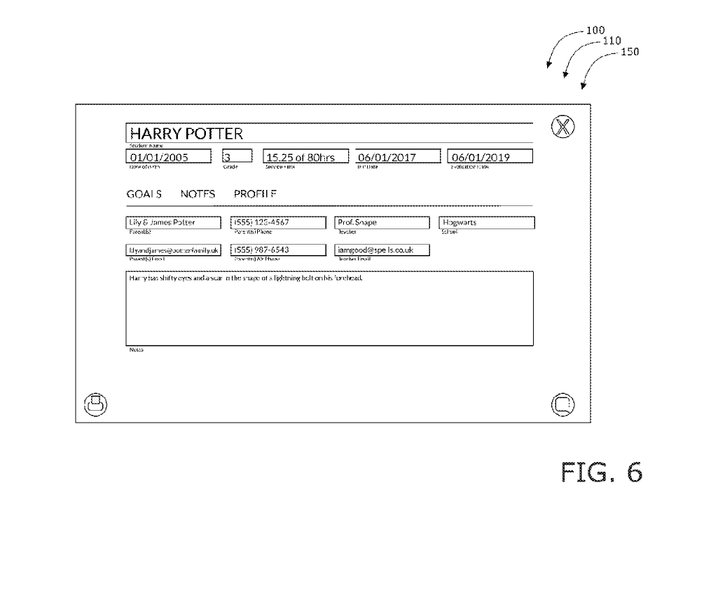

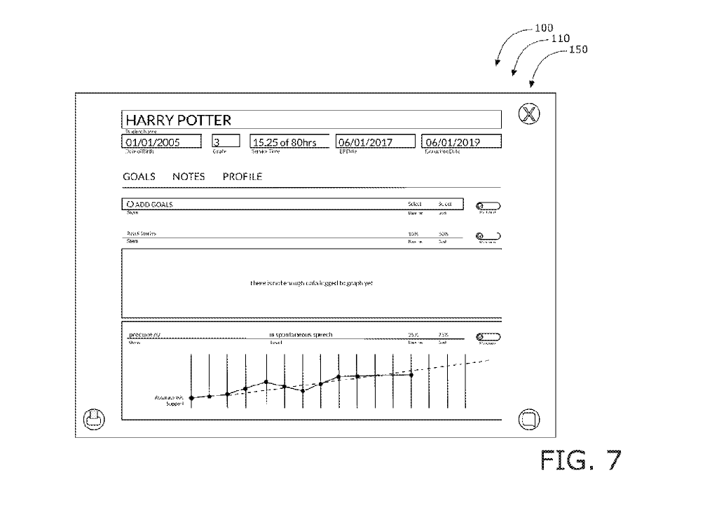

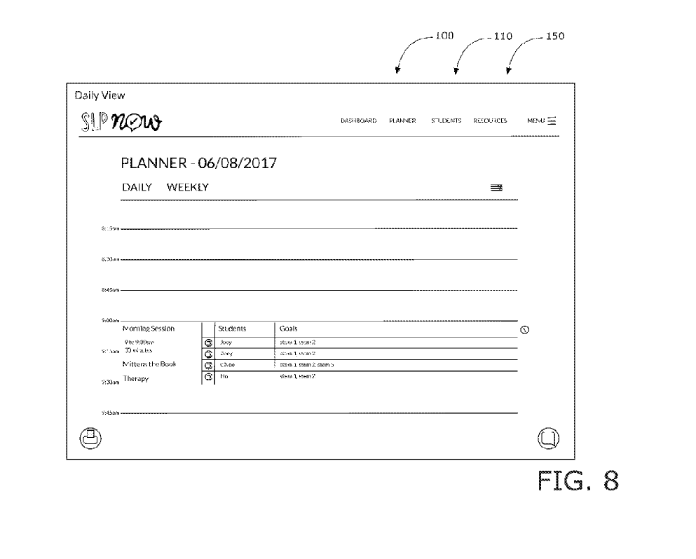

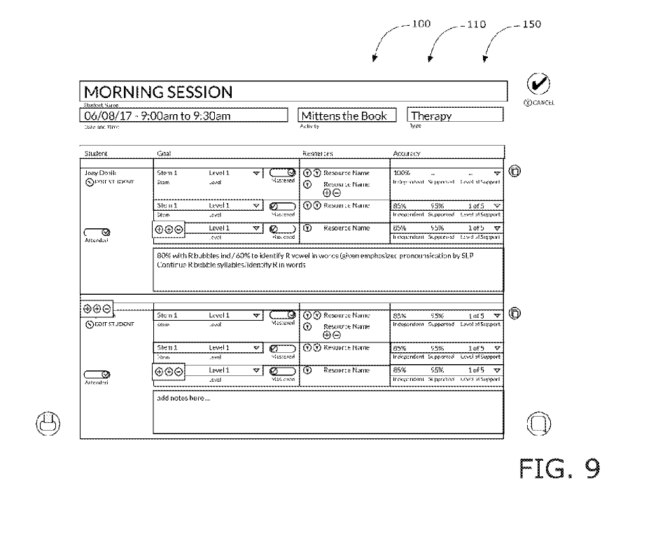

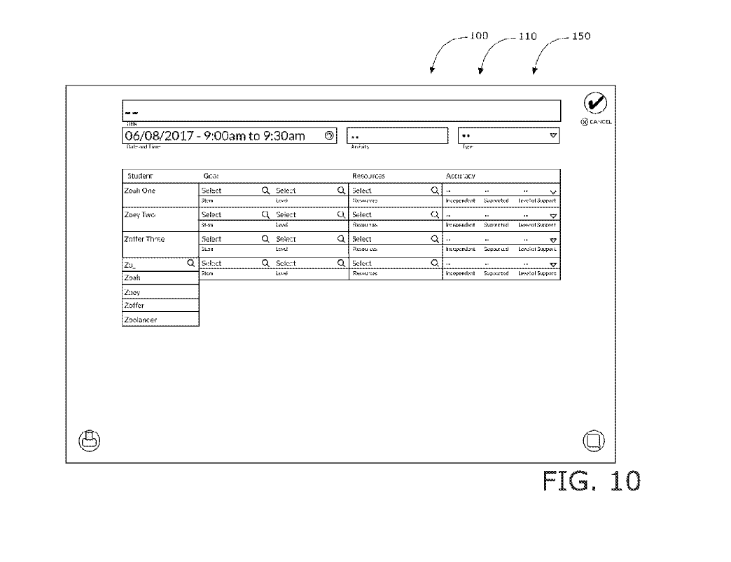

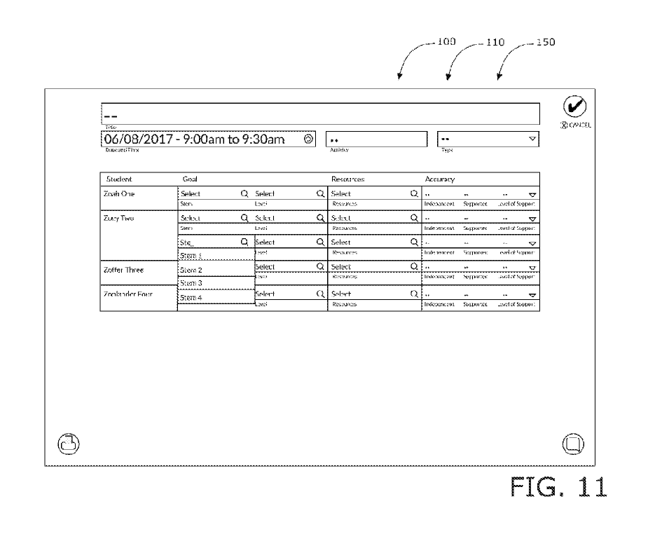

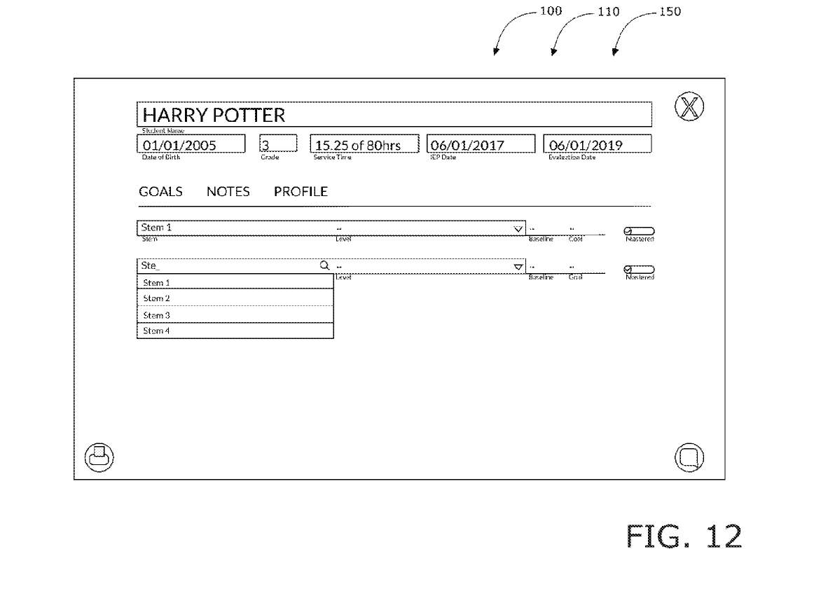

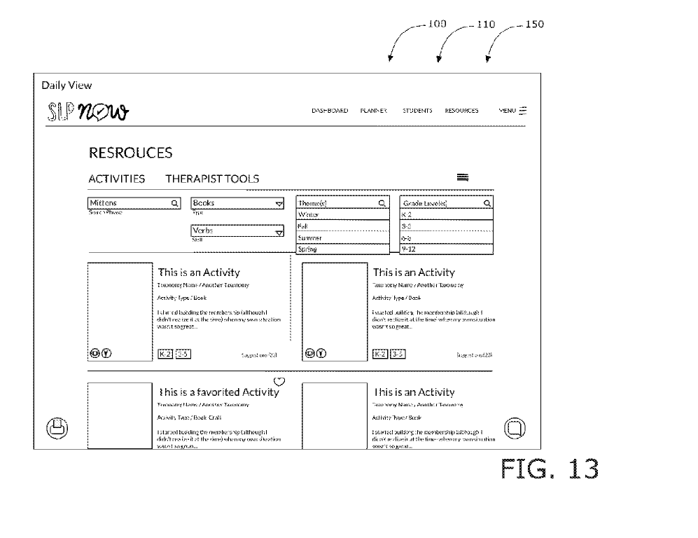

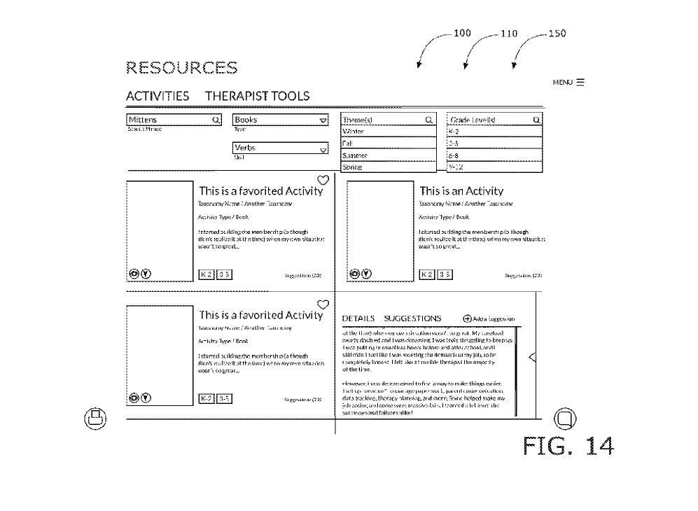

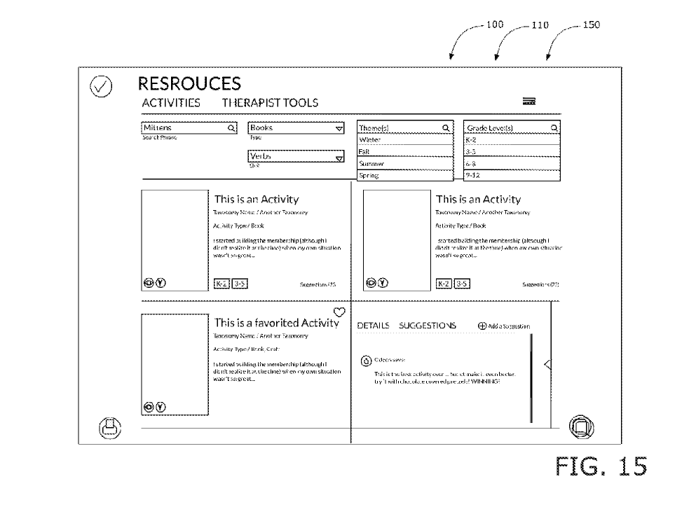

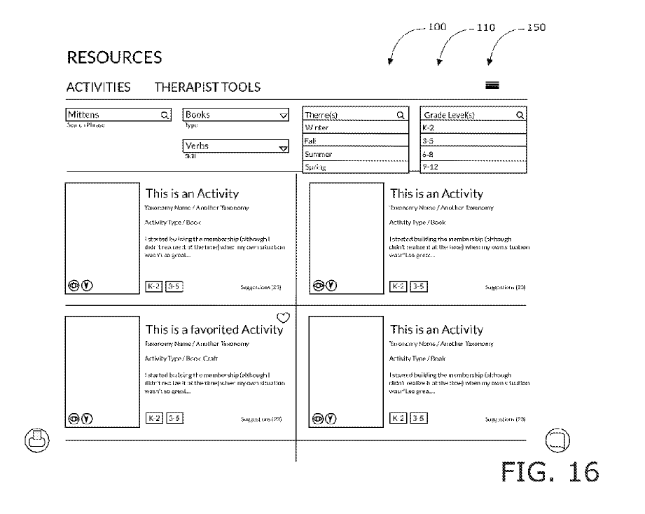

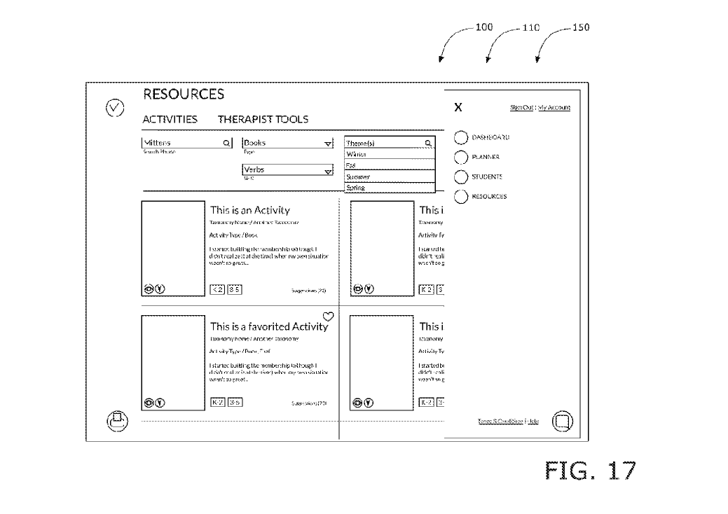

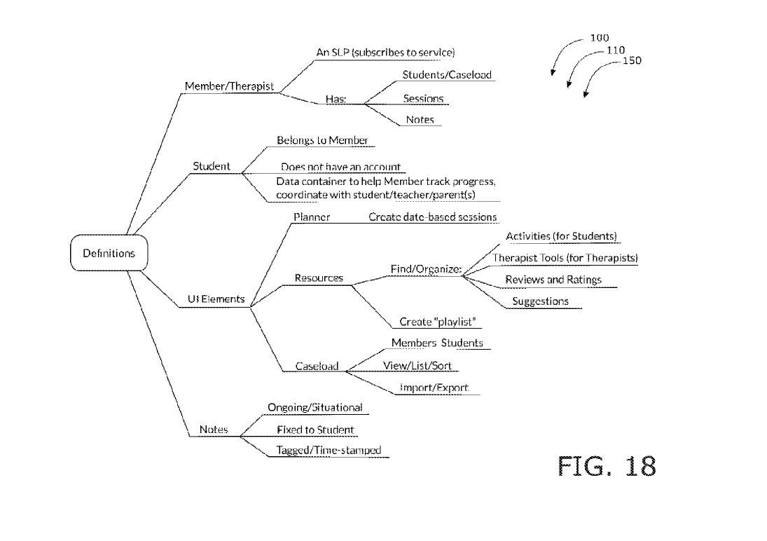

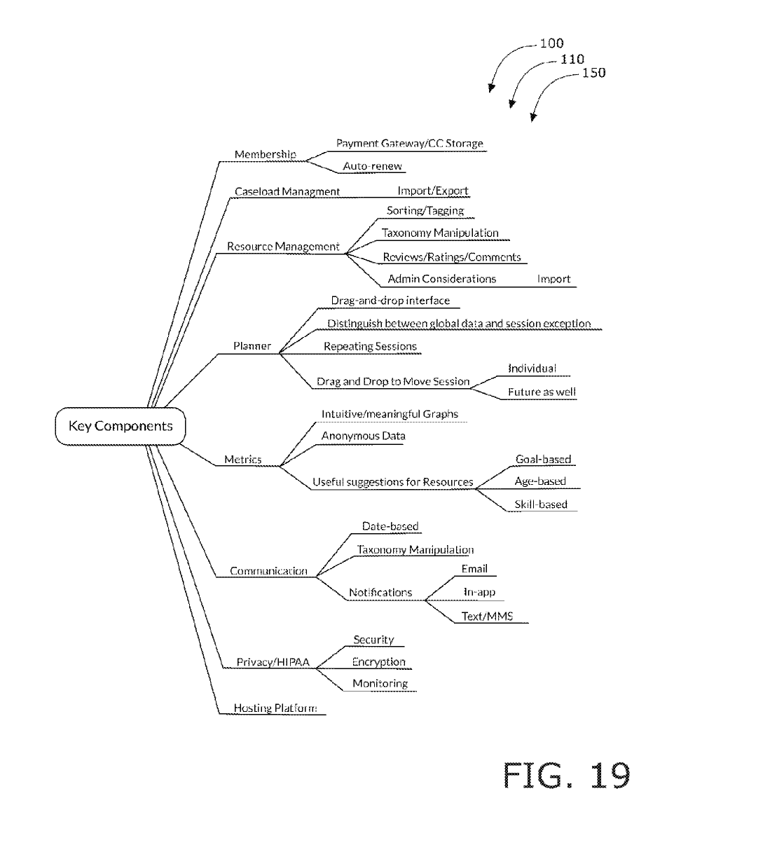

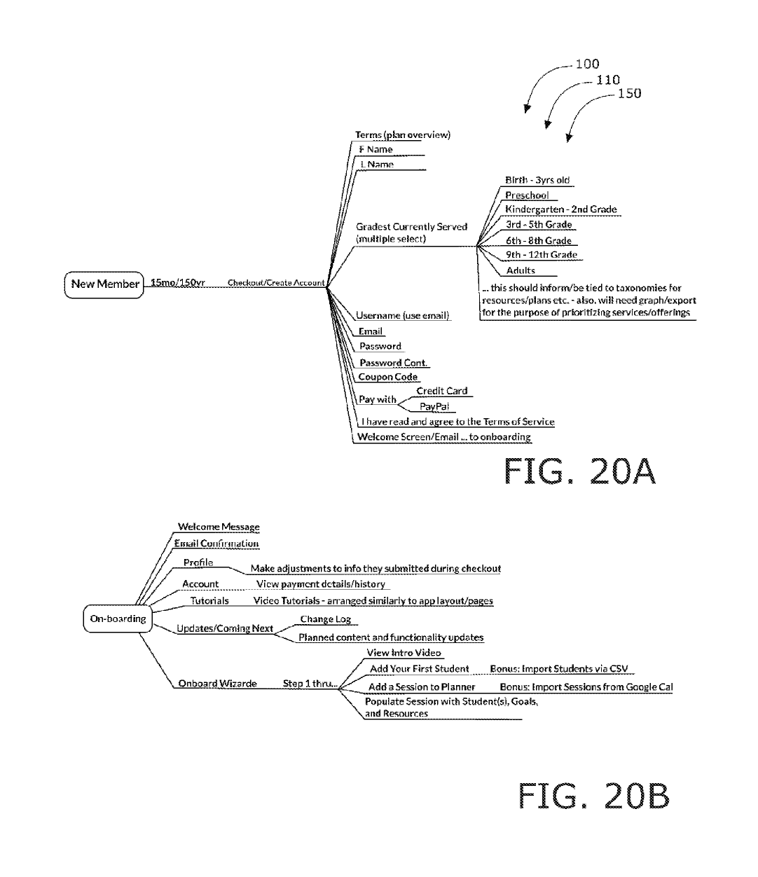

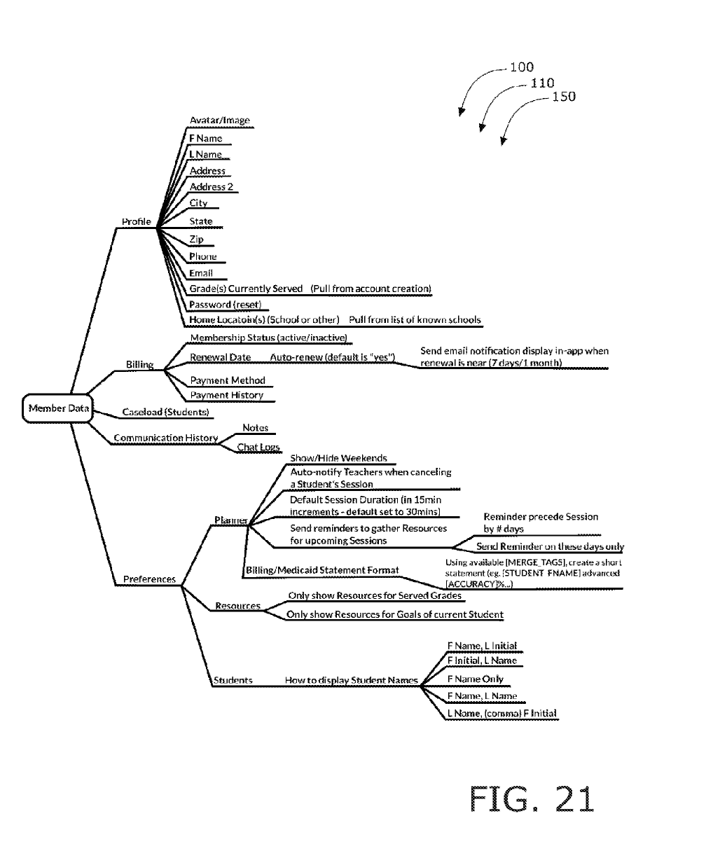

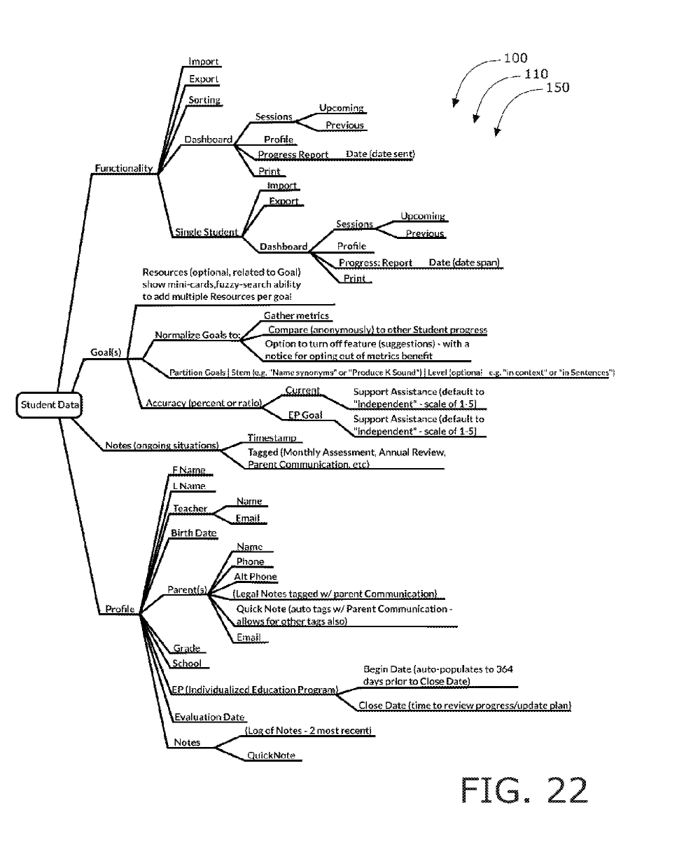

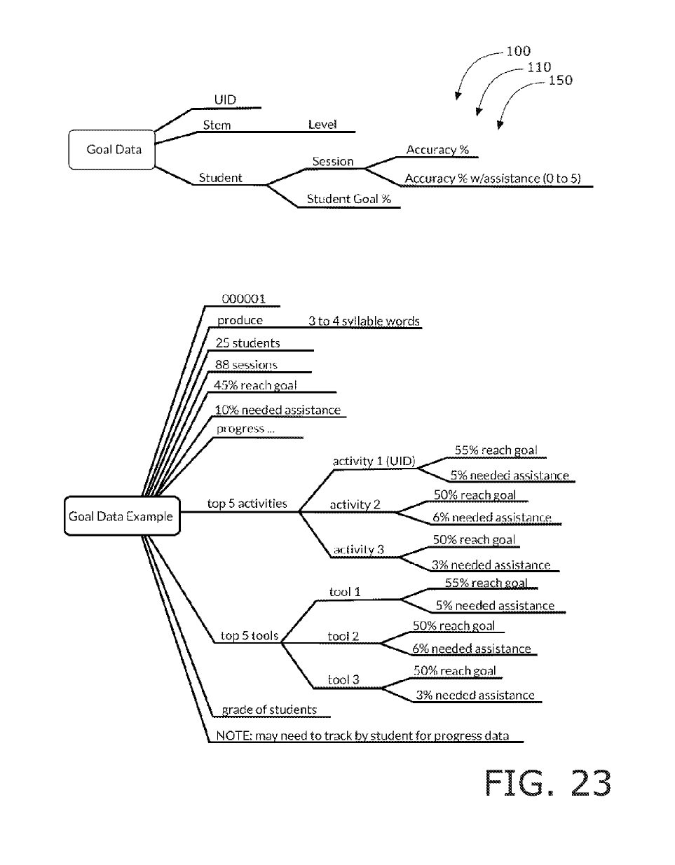

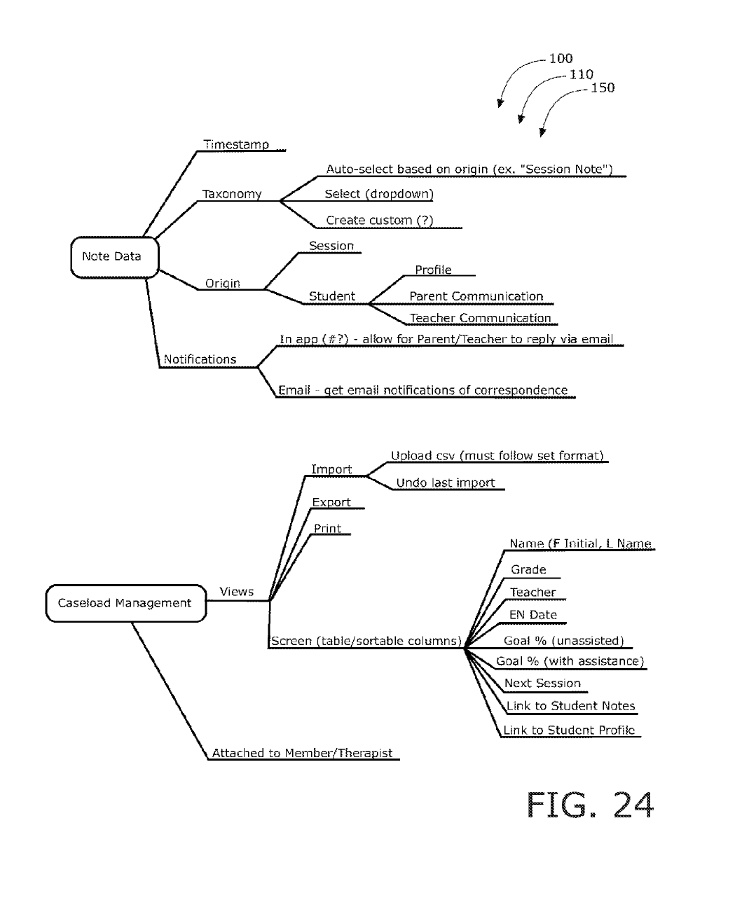

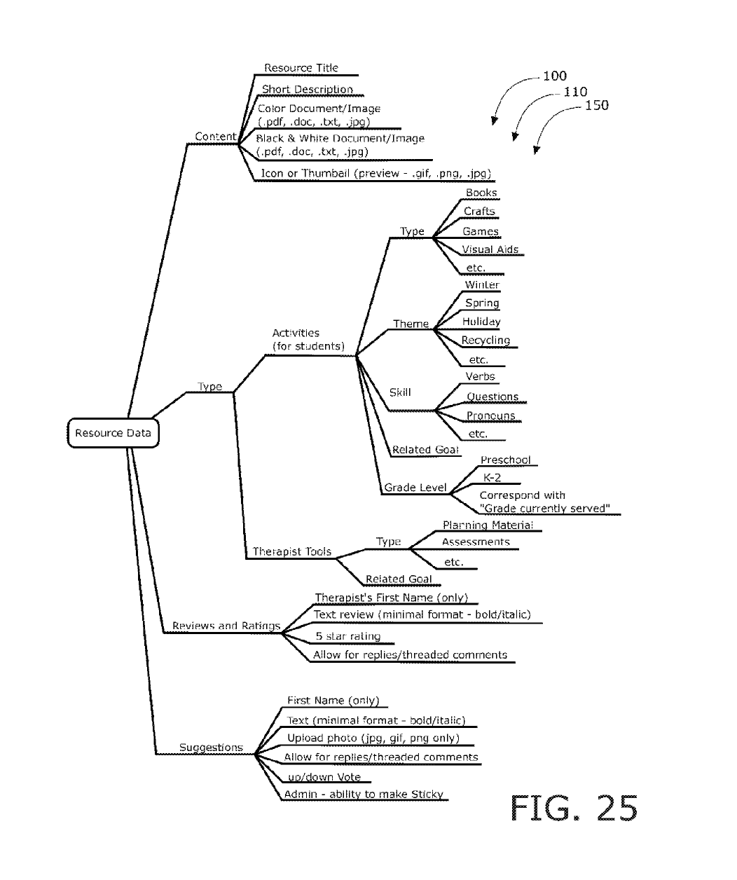

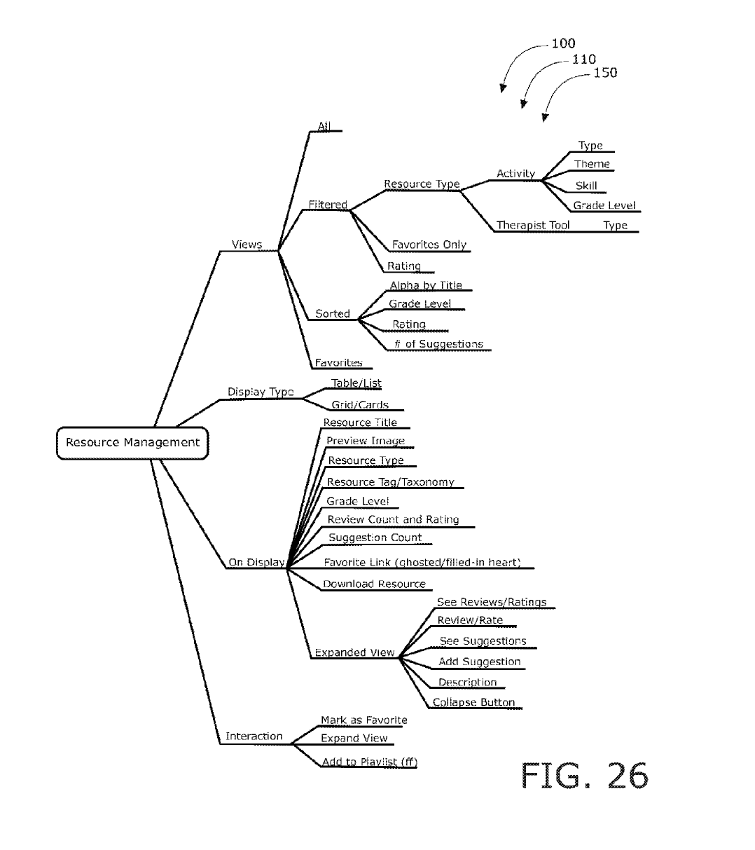

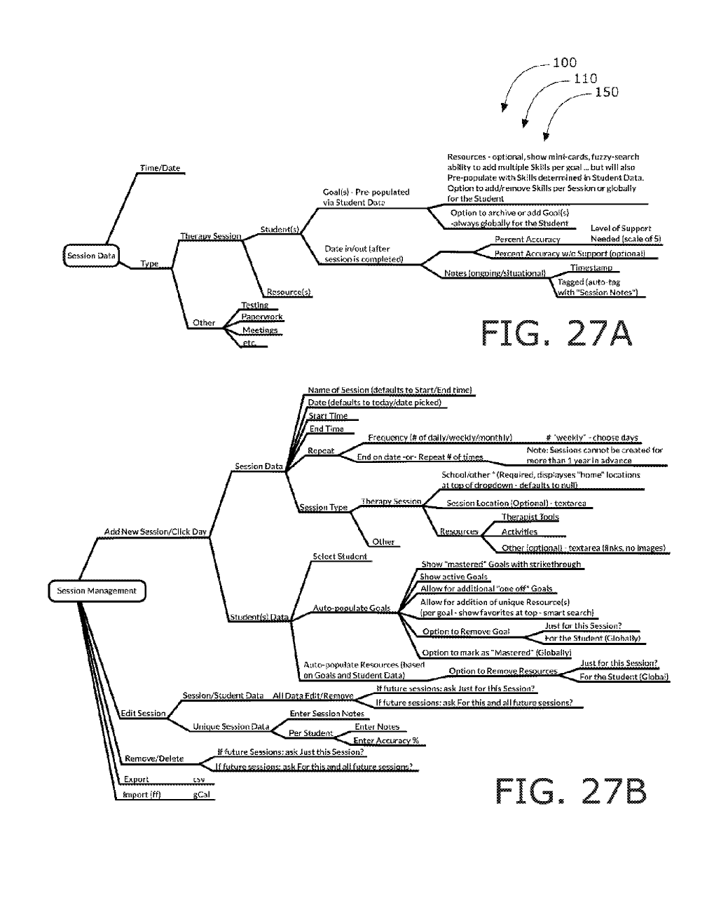

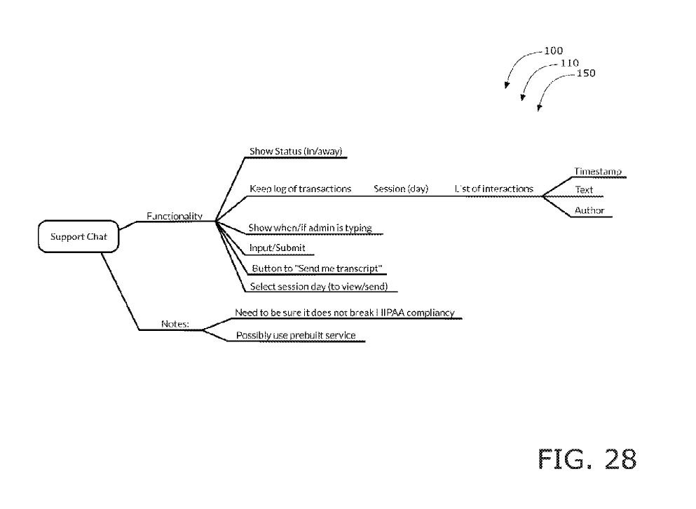

Referring now more specifically to the drawings by numerals of reference, there is shown in FIGS. 1-29, various views of an electronic teaching aid software system and method of generating a customized curriculum 100. FIG. 1 shows an electronic teaching aid software system and method of generating a customized curriculum 100 during an ‘in-use’ condition 150, according to an embodiment of the present disclosure. As illustrated, the electronic teaching aid software system and method of generating a customized curriculum 100 may include providing an electronic teaching aid software system 100, comprising a computing device 10 hosting an application and in communication with a student-user 140 via a network, a database 120 coupled to the computing device 10 and storing therein a plurality of courses 124 to be combined into a course-outline dependent upon a skill level of, the student-user 140 based on a student-profile. The electronic teaching aid software system 100 generates a course-outline to the student-user 140 via the network and allows a speech/language pathologist 144 to track progress of the student-user 140 via a plurality of therapist workstations 148. The method further comprises receiving information on a skill level of a student-user 140 via a student-profile, analyzing the student-profile, generating therapy plans and activities, tracking of the skill level of the student-user 140, and updating therapy plans and activities.

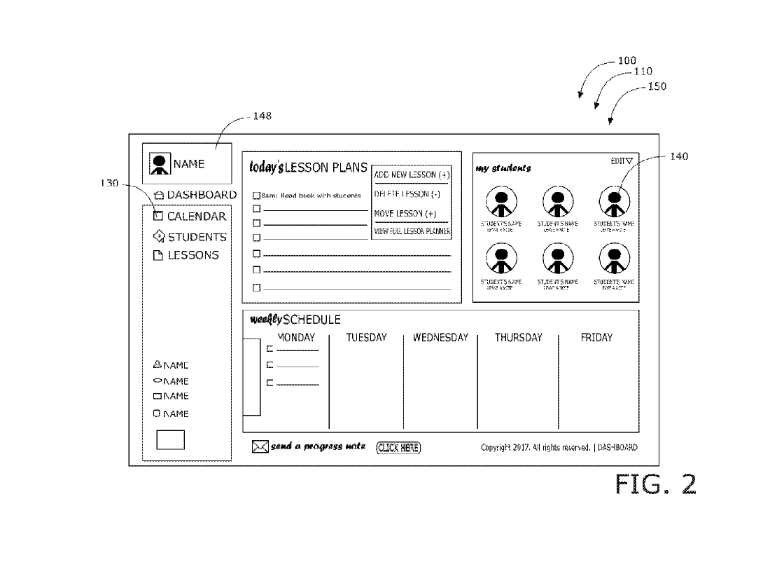

FIG. 2-17 show detailed views of the electronic teaching aid software system and method of generating a customized curriculum 100 of FIG. 1, according to an embodiment of the present disclosure. As above, the electronic teaching aid software system 100 may include providing an electronic teaching aid software system 100, receiving information on a skill level of a student-user 140 via a student-profile, analyzing the student-profile, generating therapy plans and activities, tracking of the skill level of the student-user, and updating therapy plans and activities. The method may further comprise the steps of logging progress and activity of the student-user 140 on the therapy plans and the activities, evaluating the progress and the activity of the student-user 140 on the therapy plans and the activities, generating therapy plans and activities on a weekly basis, tracking of the skill level of the student-user 140 is accomplished using tags. The tags allow members to customize the therapy plans and the activities. The electronic teaching aid software system 100 provides capacity to communicate with medical billing such as Medicaid. The electronic teaching aid software system 100 provides capacity to communicate between parents and at least one speech/language pathologist 144 which is remote from the student-user 140.

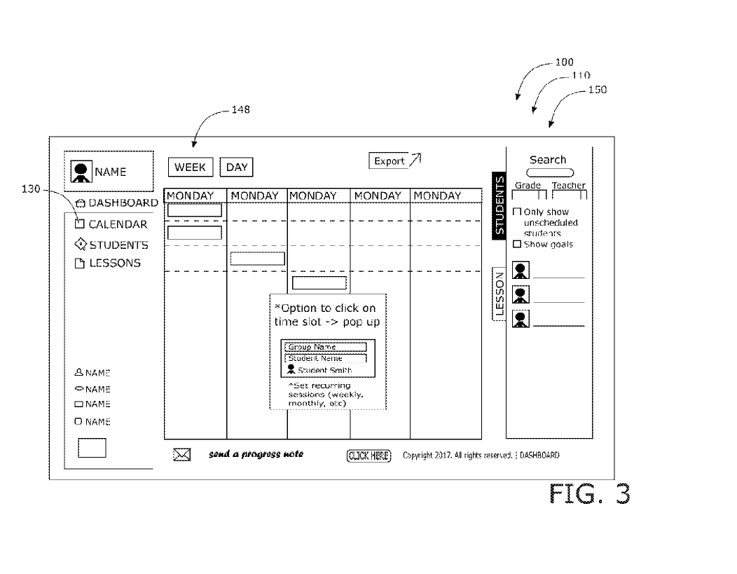

FIG. 3 shows a detailed view of the electronic teaching aid software system and method of generating a customized curriculum 100 of FIG. 1, according to an embodiment of the present disclosure. As above, the electronic teaching aid software system and method of generating a customized curriculum 100 may include a computing device 10 hosting an application and in communication with a student-user 140 and speech/language pathologist 144 via a network, a database 120 coupled to the computing device 10 and storing therein a plurality of courses to be combined into a course-outline of therapy plans and activities dependent upon a skill level of the student-user 140 based on a student-profile. The electronic teaching aid software system 100 may generate a course-outline to the student-user via the network and allows a speech/language pathologist 144 to track progress of the student-user 140 via a plurality of therapist workstations 148. The application further comprises a discussion board.

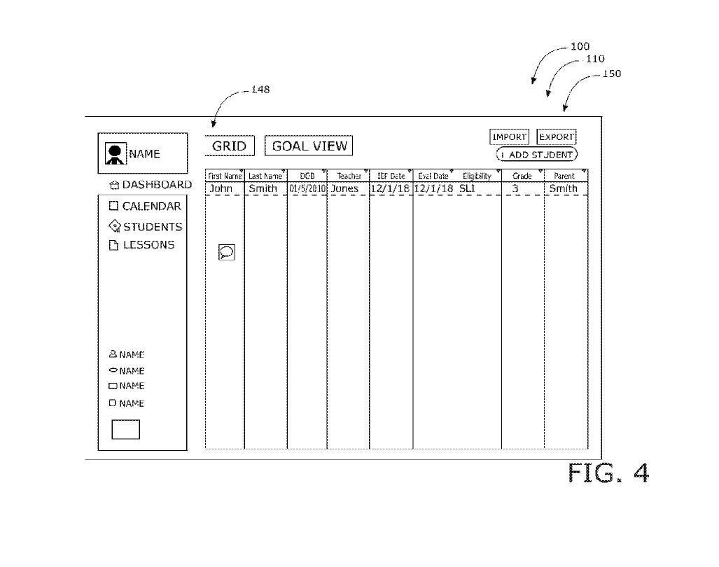

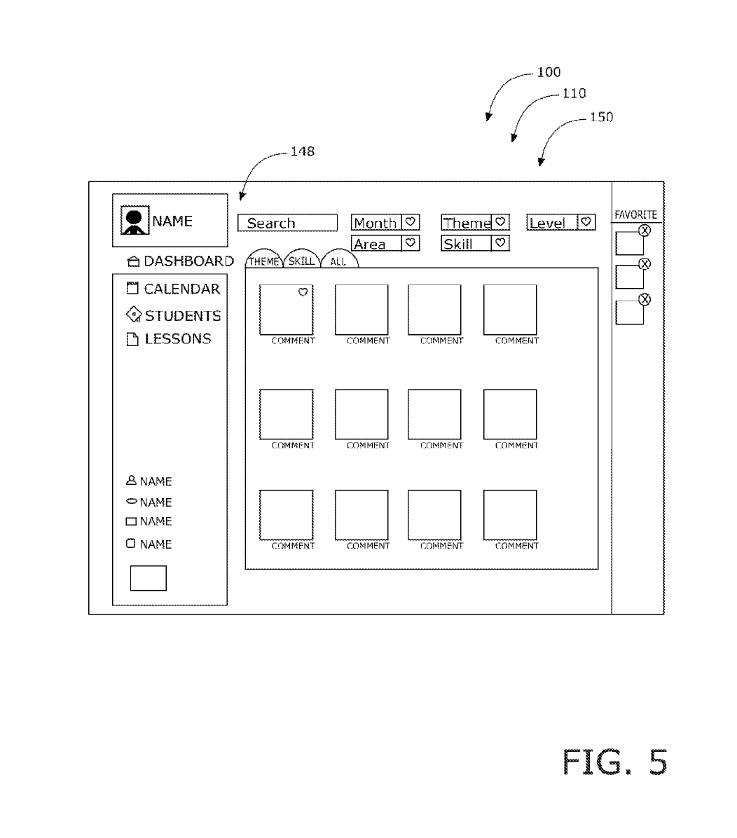

FIGS. 4-5 show a detailed view of the electronic teaching aid software system and method of generating a customized curriculum 100 of FIG. 1, according to an embodiment of the present disclosure. As above, the electronic teaching aid software system 100 may include use of a computing device 10 which may include a mobile device, desktop computer, laptop computer, or tablet or other suitable computing device 10 for displaying the software via a mobile app or web browsing. The electronic teaching aid software system 100 is displayable and able to be interreacted with via a display screen of the computing device 10. The student-profiles specify learning objectives associated with a student-user 140. The student-users 140 may be grouped based on the skill level of the student-user 140.

The application further comprises a calendar 130 for the speech/language pathologist to organize therapy plans. A calendar customization page may be displayed with options for each day of the week. The calendar customization page may provide the speech/language pathologist the ability to schedule and track therapy sessions and other appointments. Customization may include tools such a therapy/session scheduler, which may have a separate number of days and labels (i.e. Day 1, etc.). Navigation to different dates may be available so that reminders may be set by the speech/language pathologist for necessary student goals. Student profiles and therapy plan outlines may be dragged and dropped within the calendar to add their appropriate therapy plan time table. The therapy plans and the activities are designed to develop speech and language skills and impairment. The discussion board allows the speech/language pathologists 144 to share information and teaching material. The present invention may incorporate further options such as a member's connection center where speech/language pathologists 144 may discuss therapeutic practices, and provide advice to other speech/language pathologists 144.

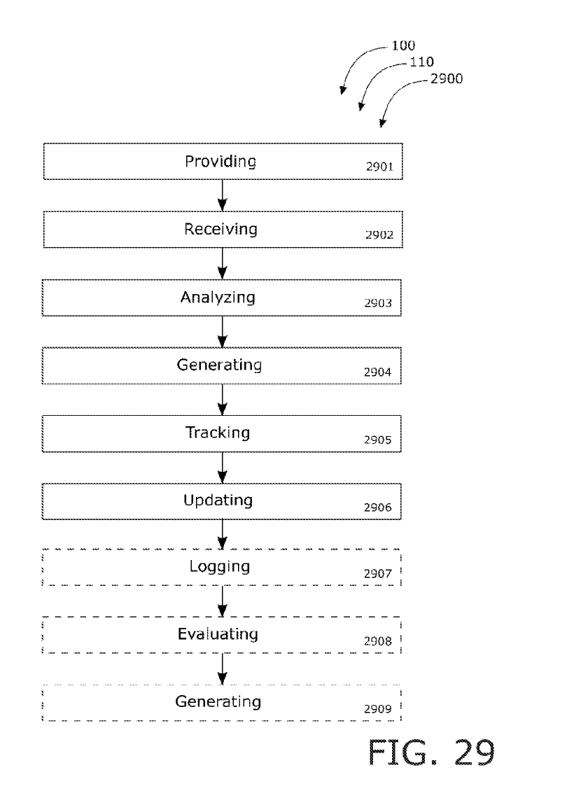

FIG. 29 shows a flow diagram illustrating a method for use 600 of the electronic teaching aid software system and method of generating a customized curriculum 100, according to an embodiment of the present disclosure. In particular, the method for use 600 of the electronic teaching aid software system and method of generating a customized curriculum 100 may include one or more components or features of the of the electronic teaching aid software system curriculum 100 as described above.

As illustrated, the method for tracking and generating a customized curriculum 500 may include the steps of: step one 601, providing an electronic teaching aid software system 100, comprising a computing device 10 hosting an application and in communication with a student-user 140 via a network 122, a database 120 coupled to the computing device 10 and storing therein a plurality of courses to be combined into a course-outline dependent upon a skill level of the student-user 140 based on a student-profile, the electronic teaching aid software system 100 generates a course-outline to the student-user 140 via the network 122 and allows a speech/language pathologist 144 to track progress of the student-user 140 via a plurality of therapist workstations 148; step two 602, receiving information on a skill level of a student-user 140 via a student-profile; step three 603, analyzing the student-profile; step four 604, generating therapy plans and activities; step five 605, tracking of the skill level of the student-user 140; step six 606, updating therapy plans and activities; step seven 607, logging progress and activity of the student-user 140 on the therapy plans and the activities; step eight 608, evaluating the progress and the activity of the student-user 140 on the therapy plans and the activities, step nine 609, generating therapy plans and activities, and updating therapy plans and activities.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An electronic teaching aid software system and method of generating a customized curriculum, the method comprising:
providing an electronic teaching aid software system, comprising:
a computing device hosting an application and in communication with a student-user via a network;
a database coupled to said computing device and storing therein a plurality of courses to be combined into a course-outline dependent upon a skill level of said student-user based on a student-profile; and
wherein said electronic teaching aid software system generates a course-outline to said user via said network and allows a speech/language pathologist to track progress of said student-user via a plurality of therapist workstations;
receiving information on a skill level of a student via a student-profile;
analyzing said student-profile;
generating therapy plans and activities;
tracking of said skill level of said student-user; and
updating therapy plans and activities.

2. The method of claim 1, further comprising logging progress and activity of said student-user on said therapy plans and said activities.

3. The method of claim 2, further comprising evaluating said progress and said activity of said student-user on said therapy plans and said activities.

4. The method of claim 1, wherein said generating therapy plans and activities is on a weekly basis.

5. The method of claim 1, wherein said tracking of said skill level of said student-user is accomplished using tags.

6. The method of claim 5, wherein said tags allow members to customize said therapy plans and said activities.

7. The method of claim 1, wherein said electronic teaching aid software system provides capacity to communicate with medical billing.

8. The method of claim 1, wherein said electronic teaching aid software system provides capacity to communicate between parents and at least one speech/language pathologist.

9. The method of claim 1, wherein said at least one speech/language pathologist is remote from said student-user.

10. An electronic teaching aid software system, comprising:
a computing device hosting an application and in communication with a student-user and speech/language pathologist via a network;
a database coupled to said computing device and storing therein a plurality of courses to be combined into a course-outline of therapy plans and activities dependent upon a skill level of said student-user based on a student-profile; and
wherein said electronic teaching aid software system generates a course-outline to said user via said network and allows a speech/language pathologist to track progress of said student-user via a plurality of therapist workstations.

11. The electronic teaching aid software system and method of generating a customized curriculum of claim 10, wherein said application further comprises a discussion board.

12. The electronic teaching aid software system and method of generating a customized curriculum of claim 10, wherein said computing device comprises a mobile device.

13. The electronic teaching aid software system and method of generating a customized curriculum of claim 10, wherein said computing device comprises a computer.

14. The electronic teaching aid software system and method of generating a customized curriculum of claim 10, wherein said student-profiles specify learning objectives associated with a student-user.

15. The electronic teaching aid software system and method of generating a customized curriculum of claim 10, wherein said student-users are grouped based on said skill level of said student-user.

16. The electronic teaching aid software system and method of generating a customized curriculum of claim 10, wherein said application further comprises a calendar for said speech/language pathologist to organize therapy plans.

17. The electronic teaching aid software system and method of generating a customized curriculum of claim 10, wherein said electronic teaching aid software system is displayable and able to be interreacted with via a display screen of said computing device.

18. The electronic teaching aid software system and method of generating a customized curriculum of claim 10, wherein said therapy plans and said activities develop speech and language skills and impairment.

19. The electronic teaching aid software system and method of generating a customized curriculum of claim 11, wherein said discussion board allows said speech/language pathologists to share information and teaching material.

20. An electronic teaching aid software system and method of generating a customized curriculum, the method comprising:
providing an electronic teaching aid software system, comprising:
a computing device hosting an application and in communication with a student-user via a network;
a database coupled to said computing device and storing therein a plurality of courses to be combined into a course-outline dependent upon a skill level of said student-user based on a student-profile; and
wherein said electronic teaching aid software system generates a course-outline to said user via said network and allows a speech/language pathologist to track progress of said student-user via a plurality of therapist workstations;
receiving information on a skill level of a student-user via a student-profile;
analyzing said student-profile;
generating therapy plans and activities;
logging progress and activity of said student-user on said therapy plans and said activities;
tracking of said skill level of said student-user;
evaluating said progress and said activity of said student-user on said therapy plans and said activities;
generating therapy plans and activities; and
updating therapy plans and activities.
